(19) United States
(12) Patent Application Publication
(10) Pub. No.: US 2024/0248929 A1
(43) Pub. Date: Jul. 25, 2024

(54) DEVICE AND METHOD FOR PROCESSING A DIGITAL MODEL OF A SYSTEM

(71) Applicant: Orange SA, Issy-les-Moulineaux (FR)

(72) Inventors: Gilles Privat, CHATILLON (FR); Philippe Parverdi Raipin, CHATILLON (FR); Thomas Hassan, CHATILLON (FR); Thierry Coupaye, CHATILLON (FR); Sebastien Bolle, CHATILLON (FR)

(21) Appl. No.: 18/564,255

(22) PCT Filed: Apr. 5, 2022
(86) PCT No.: PCT/FR2022/050631

§ 371 Date: Nov. 27, 2023

(30) Foreign Application Priority Data
May 27, 2021 (FR) FR2105523

(51) Int. Cl. G06F 16/901

(52) U.S. Cl. CPC G06F 16/9024

(57) ABSTRACT

A method for processing a digital model of a system comprising entities is described, the digital model comprising a structural graph representing the entities of the system by interconnected nodes and an over-graph corresponding to an abstraction of the structural graph and comprising nodes representing sets, at least one of the nodes of the structural graph being associated with at least one of the nodes of the over-graph. The method is implemented by an electronic device and includes determining a node of the over-graph capable of creating an overload; generating an indexing node representing a sub-set of the set represented by the determined node, the sub-set inheriting properties from the set and comprising at least one additional characteristic; associating the indexing node and the determined node; identifying nodes of the structural graph which are directly associated with the determined node and which share the at least one additional characteristic; and associating the identified nodes with the indexing node.

### TECHNICAL FIELD

The invention relates to the general field of the processing of digital models of systems, and more particularly concerns a method for processing a digital model of a system. The invention also concerns a method for searching for information represented by a pattern graph in a digital model of a system.

### PRIOR ART

A digital twin is a digital model of an object or of a system which is powered by a stream of data generally obtained using digital sensors. This data stream coming from the real world allows the digital twin to maintain an up-to-date representation of the state of the system it represents and, possibly, to predict its future state. The digital twins prove to be particularly useful to represent complex systems. This is for example the case of smart cities whose digital twin makes it possible to track and predict the vehicle traffic, or even make decisions aimed at regulating the traffic.

Patent document US 2020/0090085 discloses a system for managing digital twins modeling physical objects. The system is represented by a graph of digital twins, and each physical object in the real world corresponds to a sub-graph. The system, which reflects a physical reality, is dynamic, and nodes and/or edges of the graph can therefore appear or disappear over time. The representation of the system can be improved by integrating ontologies therein. These ontologies are integrated into the graph of digital twins in the form of a set of nodes and edges.

Requests that query this graph-oriented model are made, and the model is then traversed in order to find information through the relations described in the model, and to simulate or predict some situations. However, when a node of the graph comprises a significant number of incident arcs, this considerably slows down the traversal of the graph of digital twins, and therefore generates a request processing period, or a combinatorial explosion, since the calculation time increases exponentially, which makes it impossible in practice to obtain a result. The invention aims in particular to overcome these drawbacks.

### DISCLOSURE OF THE INVENTION

According to a first aspect, the invention concerns a method for processing a digital model of a system comprising entities, the digital model comprising a structural graph and a super-graph, the structural graph representing the entities of the system by interlinked nodes; the super-graph corresponding to an abstraction of the structural graph and comprising nodes representing sets; at least one of the nodes of the structural graph being associated with at least one of the nodes of the super-graph; the method comprising the following steps implemented by an electronic device:
determining a node of the super-graph capable of creating an overload during traversal of the digital model; and, in response to this determination,
generating an indexing node representing a sub-set of the set represented by the node capable of creating an overload, the sub-set inheriting properties from the set, the sub-set comprising at least one additional characteristic; associating the indexing node and the node capable of creating an overload; identifying the nodes of the structural graph directly associated with the node capable of creating an overload and which share the at least one additional characteristic; and associating the identified nodes with the indexing node.

Thus, the invention makes it possible to prevent a slowdown or a combinatorial explosion, by automatically identifying a node of the super-graph capable of creating an overload, and by generating a new node making it possible to reduce the probability that such an overload occurs.

In one particular embodiment, said system is a complex system. Within the meaning of the invention, “complex system” means a set composed of a plurality of entities whose local interactions bring out global properties that are difficult to predict simply by knowing the properties of these entities. A smart city is an example of a complex system that uses different digital sensors that provide information for effectively managing the resources of the city. This for example comprises data collected from individuals, vehicles, buildings, objects connected to a network (and sometimes called “Internet of Things objects”), and which thus make it possible to effectively manage the traffic and transport systems, the water and/or energy supply networks, the information systems, the administrative buildings, etc.

Thus, in one particular embodiment, the system comprises in particular entities such as digital sensors, connected objects or sensors of the Internet of Things, and/or electronic devices such as smartphones. In one particular embodiment, the determination step comprises a step of determining the indegree and/or outdegree of the node, and a step of comparing the determined degree with a predetermined value.

In one particular embodiment, the determination step comprises a step of analyzing requests previously received by the node of the super-graph capable of creating an overload.

In one particular embodiment, the method comprises a step of determining that several of the entities represented by nodes of the structural graph associated with the node of the super-graph capable of creating an overload have the same location; and the generated indexing node has the location as an additional characteristic.

In one particular embodiment, the super-graph comprises:
a semantic graph comprising nodes, each node representing a set of the super-graph called semantic category, these nodes being interlinked by arcs representing a subsumption relation or a semantic relation; at least one of the nodes of the structural graph being linked to at least one of the nodes of the semantic graph by an arc characterizing that the at least one of the nodes of the structural graph represents an instance of the semantic category represented by the at least one node of the semantic graph; and,
a hyper-structural graph comprising hyper-nodes, each hyper-node representing a set of the super-graph called extensional set; a hyper-node being associated with a plurality of nodes of the structural graph; and, a hyper-node being linked to at least one other hyper-node or to at least one node of the semantic graph,

and the indexing node belongs to the semantic graph and/or to the hyper-structural graph.

This multi-level organization improves the semantics associated with each of the entities represented by a node of the structural graph, but also the processing operations and/or the requests that can be made on this digital model.

In one particular embodiment, the node capable of creating an overload belongs to the semantic graph (respectively to the hyper-structural graph), and the method comprises a step of determining that several of the nodes of the structural graph associated with the node capable of creating an overload are also associated with another node of the hyper-structural graph (respectively of the semantic graph), the node capable of creating an overload representing a first set, the other node representing a second set, and the generated indexing node represents a sub-set of the first and second sets.

In one particular embodiment, the structural graph and at least a portion of the super-graph are stored within distributed hardware architecture compliant with the edge computing.

In one particular embodiment, the different steps of the method for processing a digital model of a system are determined by computer program instructions.

Consequently, the invention also relates to a computer program on an information medium, this program being capable of being implemented in an electronic device for processing a digital model of a system or more generally in a computer, this program including instructions adapted for the implementation of the steps of a method for processing a digital model of a system as described above.

This program can use any programming language, and be in the form of source code, object code, or intermediate code between source code and object code, such as in a partially compiled form, or in any other desirable shape.

The invention also relates to a digital model of a system obtained by the processing method mentioned above.

According to a second aspect, the invention relates to a method for searching for information represented by a pattern graph in a digital model of a system, the method comprising the following steps implemented by an electronic device:
traversing the digital model by checking whether a portion of the digital model corresponds to the pattern graph; and if so,
obtaining information that makes it possible to identify the portion of the digital model.

In one particular embodiment, the different steps of the method for searching for information represented by a pattern graph in a digital model of a system are determined by computer program instructions.

Consequently, the invention also relates to a computer program on an information medium, this program being capable of being implemented in an electronic device for searching for information represented by a pattern graph in a digital model of a system, or more generally in a computer, this program including instructions adapted for the implementation of the steps of a method for searching for information represented by a pattern graph in a digital model of a system as described above.

This program can use any programming language, and be in the form of source code, object code, or intermediate code between source code and object code, such as in a partially compiled form, or in any other desirable form.

The invention also relates to an information or recording medium readable by a computer, and including instructions of a computer program such as mentioned above.

The information or recording medium can be any entity or device capable of storing the program. For example, the support can include a storage means, such as a ROM (e.g., a PROM, EPROM, EEPROM), for example a CD ROM or a microelectronic circuit ROM, or a magnetic recording means, for example a floppy disk or a hard disk.

On the other hand, the information or recording medium can be a transmissible medium such as an electrical or optical signal, which can be conveyed via an electrical or optical cable, by radio or by other means. The program according to the invention can be particularly downloaded from an Internet type network.

Alternatively, the information or recording medium can be an integrated circuit in which the program is incorporated, the circuit being adapted to execute or to be used in the execution of one of the methods in question.

### BRIEF DESCRIPTION OF THE DRAWINGS

Other characteristics and advantages of the present invention will emerge from the description given below, with reference to the appended drawings which illustrate one exemplary embodiment devoid of any limitation. In the figures:

FIGS. 1A-1B schematically represents two examples of architecture of a system in which the invention can be implemented;

FIG. 2 schematically represents an electronic device according to one exemplary embodiment of the invention;

FIG. 3 illustrates an example of a portion of digital model 300 of a system (here a building) that can be processed during an implementation of the method of FIG. 4 or of the method of FIG. 5;

FIG. 4 represents, in a flowchart, the main steps of a method for processing a digital model of a digital model of a system, according to one exemplary embodiment of the invention;

FIG. 5 represents, in a flowchart, the main steps of a method for searching for information represented by a pattern graph in a digital model of a system, according to one exemplary embodiment of the invention; and,

FIGS. 6A-6B schematically illustrates an example of a graph-oriented request applied on the digital model of FIG. 3 (FIG. 6A), and the result of this request (FIG. 6B).

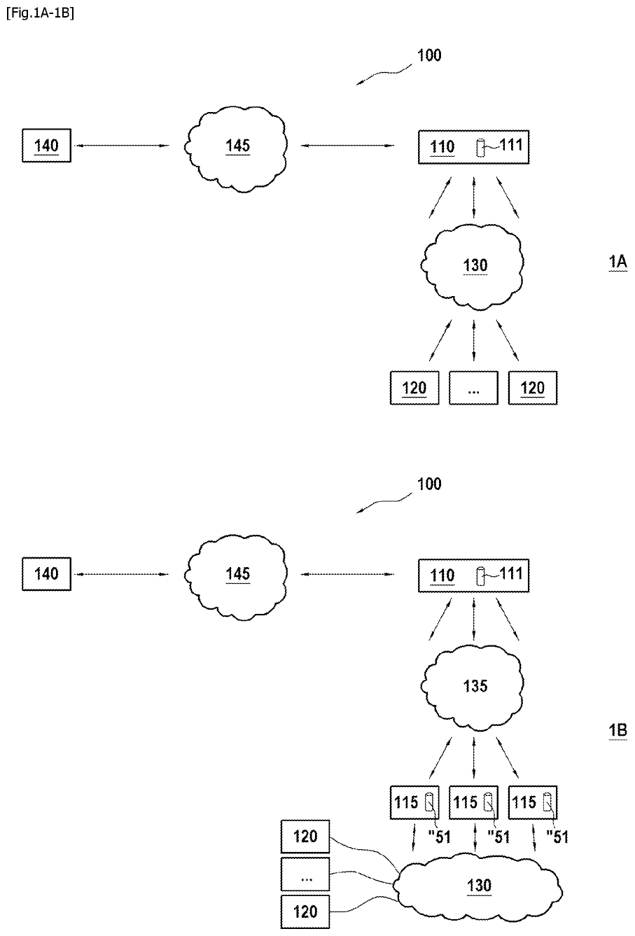

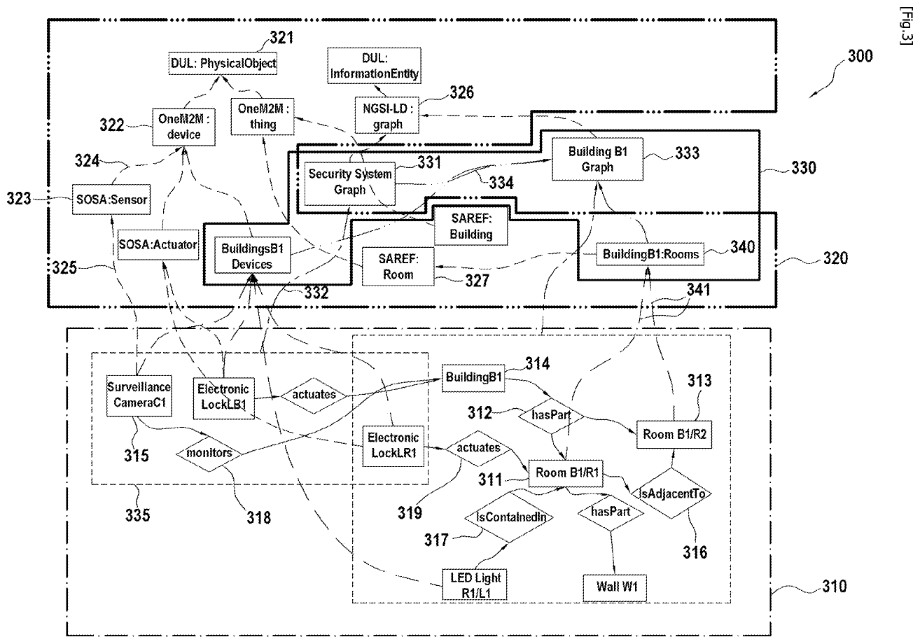

### DESCRIPTION OF THE EMBODIMENTS

[FIG. 1A-1B] schematically represents two examples of architecture of a system in which the invention is implemented. The system 100 comprises a server 110 which hosts a graph-oriented database 111. This database follows, for example, the model known as “property graphs”, in which a node corresponds to an “entity” (e.g., an entity of a structural graph or a set of a super-graph whose roles will be described below with reference to FIG. 3), an arc corresponds to a relation, and a “property” corresponds to a specific characteristic of an entity, of a set or of a relation. This model makes it possible to exploit the data, whose example of representation is illustrated in FIG. 3, through requests called graph-oriented requests. The information model NGSI-LD is an example of a formal specification of the “property graphs” model recently published by ETSI. 30 FIG. 1A illustrates a fully centralized architecture, and a dedicated server is then used to host the database 111. Entities 120 (e.g., digital sensors) are connected to the server 110 through a telecommunications network 130, for example an Internet network, a Wi-Fi network, a Bluetooth network, or a fixed or mobile telephone network. Optionally, a client 140 is connected to the server 110 through a telecommunications network 145, for example an Internet network, a Wi-Fi network, a Bluetooth network, or a fixed or mobile telephone network. The telecommunications networks 130 and 145 may be distinct or constitute only one network.

FIG. 1B illustrates an architecture meeting the principles of the edge computing (edge cloud). The data are distributed on the server 110, and on several servers called distributed servers 115, each hosting a database 1151. Entities 120 (e.g., digital sensors) are connected to the distributed servers 115 through a telecommunications network 130. The distributed servers 115 are connected to a server 110 through a telecommunications network 135. Optionally, a client 140 is connected to the server 110 through a telecommunications network 145. The telecommunications networks 130, 135 and 145 can be distinct or constitute only one network.

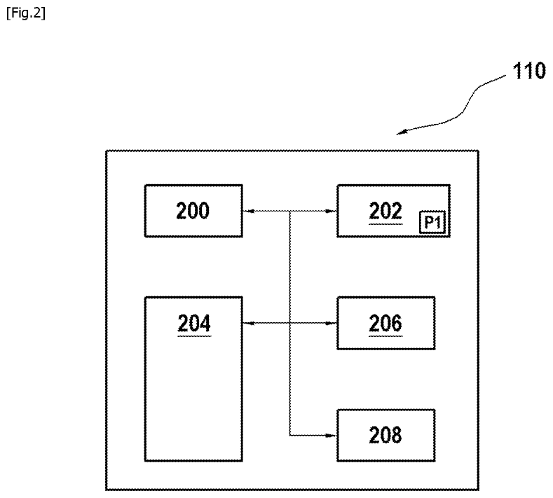

FIG. 2 schematically represents an example of an electronic device according to one embodiment of the invention. This electronic device corresponds for example to the server 110 or to one of the distributed servers 115.

The electronic device includes in particular a processor 200, a read-only memory 202 (of the “ROM” type), a rewritable non-volatile memory 204 (of the “EEPROM” or “NAND Flash” type for example), a rewritable volatile memory 206 (of the “RAM” type), and a communication interface 208.

The rewritable non-volatile memory 204 of the electronic device constitutes a recording medium in accordance with one exemplary embodiment of the invention, readable by the processor 200 and on which a computer program P1 in accordance with one exemplary embodiment of the invention is recorded. As a variant, the computer program P1 is stored in the read-only memory 202. The computer program P1 can allow the electronic device to implement a processing method in order to optimize the traversal of a digital model of a system.

This computer program P1 can thus define functional and software modules, configured to implement the steps of a processing method in accordance with one exemplary embodiment of the invention, or at least part of these steps. These functional modules rely on or control the hardware elements 200, 202, 204, 206 and 208 of the electronic device mentioned above. They may comprise in particular here a determination module, a generation module, an association module, and an identification module.

The rewritable non-volatile memory 204 of the electronic device can also comprise a second computer program P2 in accordance with one exemplary embodiment of the invention. As a variant, the second computer program P2 is stored in the read-only memory 202. The computer program P2 can allow the electronic device to implement a method for searching for information represented by a pattern graph in a digital model of a system.

This second computer program P2 can define functional and software modules, configured to implement the steps of a research method in accordance with one exemplary embodiment of the invention, or at least part of these steps. They can comprise in particular here a traversal module and an obtaining module.

The rewritable non-volatile memory 204 can store a digital model 300 comprising a structural graph 310 as well as a super-graph, whose roles will be described below with reference to FIG. 3. Furthermore, the client 140 can also have the conventional architecture of a computer, and can include in particular a processor, a read-only memory (of the “ROM” type), a rewritable non-volatile memory (of the “EEPROM” or “NAND Flash” type for example), a rewritable volatile memory (of the “RAM” type), and a communication interface.

Each rewritable non-volatile memory can constitute a recording medium in accordance with one exemplary embodiment of the invention, readable by the associated processor and on which a computer program in accordance with one exemplary embodiment of the invention is recorded. As a variant, the computer program is stored in the associated read-only memory. The computer program can allow the implementation of at least part of the processing method and/or of the research method in accordance with one exemplary embodiment of the invention.

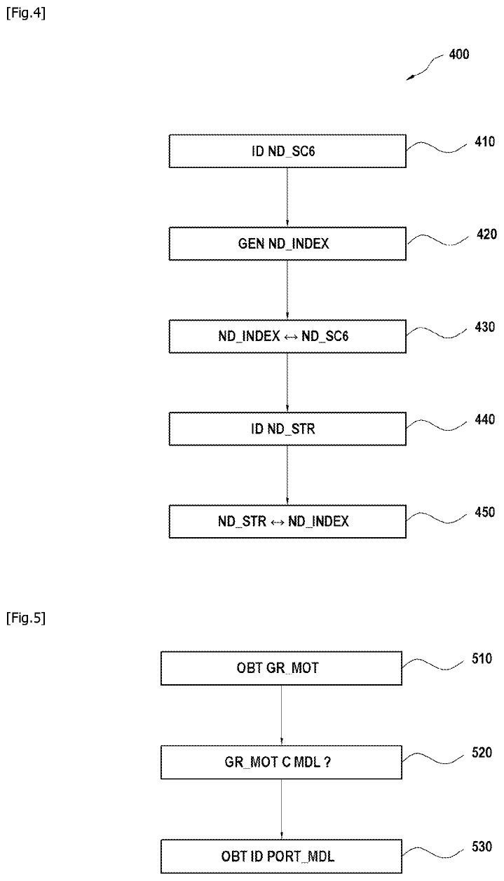

FIG. 3 illustrates one example of a digital model portion 300 of a system (here a building) that can be processed during an implementation of the method of FIG. 4 or the method of FIG. 5.

The model also makes it possible to represent a complete system, such as a city, which comprises digital sensors, connected objects or sensors from the Internet of Things, electronic devices such as smartphones, (unconnected) physical objects and/or heterogeneous sub-systems that make up the system represented.

The sub-systems are heterogeneous in the sense that each sub-system is capable of manipulating data that are potentially of a different nature from those of another sub-system of the model. The digital model according to the invention comprises a structural graph 310. When the system to be represented is complex, several structural graphs (i.e., which are not directly interlinked) may be necessary to describe it. A structural graph comprises nodes representing the entities (i.e., uniquely identifiable instances) of the system, and arcs (i.e., directed edges) linking the nodes, with each arc linking two different nodes. An entity can be a physical object, an electronic device (e.g., a sensor, a video surveillance camera, a mobile terminal), but it can also correspond to a place (e.g., a parking space, a room of a building, the building itself, a neighborhood, a city). An arc between two nodes describes a relation between two entities and can for example represent an inclusion relation (e.g., isContainedIn 317) in order to specify that an entity is physically or logically contained in another entity, a relation in order to specify that an entity corresponds to part of another entity (e.g., hasPart 312), a control or supervision relation (e.g., monitors 318 or actuates 319) (for example, a video surveillance camera monitors a building, a electronic lock actuates the opening of a door), or an adjacency relation (e.g., isAdjacentTo 316).

One or more properties can be associated with an entity or with a relation (an arc) of the structural graph.

FIG. 3 illustrates by way of example that a room B1/R1 311 corresponds to a part 312 of a building B1 314. The building B1 314 could be characterized by an “address” property (not represented) that would for example have “Rennes” as value.

According to one particular embodiment, when the system is dynamic and comprises entities that appear, disappear, or which have properties evolving over time, the structural graph is automatically updated so as to be able to best reflect the state of the system it represents.

In this way, the information captured by the entities of the system (e.g., the images from a video surveillance camera or the data from other sensors) is analyzed, and when a new entity is for example identified, a new node representing this new entity is added to the structural graph.

According to the invention, a model such as the model 300 also comprises a super-graph which corresponds to an abstraction of the structural graph. The super-graph corresponds either to a semantic graph 320, or to a hyper-structural graph 330, or to the combination of the two. The super-graph comprises nodes, each representing a set corresponding either to a semantic category of the semantic graph 320, or to a set called extensional set of the hyper-structural graph 330.

The semantic graph 320 is composed of nodes representing semantic categories. These semantic categories come from ontologies. In computer science and information science, an ontology is a structured set of semantic categories and of relations between these categories, in a particular domain. By relation, it is meant subsumption relations or other semantic relations between the categories, for example to specify that they are disjoint. An ontology allows different actors in the same domain to collaborate together through a common representation of the information in a domain. Generally, an ontology comprises reasoning skills so as to be able to infer new knowledge. Preferably, a semantic graph such as the graph 300 comprises semantic categories defined by several ontologies. The ontology defining a semantic category of the semantic graph is identified by a namespace prefixed to the name of the semantic category. Thus, the category “Physical object” 321 (PhysicalObject) is defined by the DUL ontology, a particular version of the high-level ontology DOLCE (Descriptive Ontology for Linguistic and Cognitive Engineering) which defines concepts common to all domains. Also, the “Physical object” category 321 is identified DUL:PhysicalObject in FIG. 3. Similarly, the “Device” category 322 (Device) is defined by the OneM2M ontology which is specific to the domain of the Internet of Things and of the machine-to-machine communication. Also, the “Device” category 322 is identified OneM2M:Device in FIG. 3.

Finally, the “Sensor” category (Sensor) is defined by the SOSA (Sensor, Observation, Sample, and Actuator Ontology) ontology, defined by the W3C, and which aims to describe the domain of the sensors and their observations. Also, the “Sensor” category 323 is identified SOSA:Sensor in FIG. 3. These semantic categories are, for example, interlinked by the subsumption relation “is a subclass of” 324 (e.g., RDFS:SubClassOf). This relation is transitive. Thus, the Sensor semantic category 323 is a Device subclass 322 and a Physical Object subclass 312, and the Device category 322 is itself a Physical Object subclass 312.

According to one particular embodiment, one or more properties (or constraints) are associated with a semantic category. Preferably, the arcs of the semantic graph are defined within the framework of the RDF/RDFS/OWL meta-model (e.g., rdf:type, rdfs:subClassOf, rdfs:domain, rdfs:range). The nodes of the structural graph can be associated with those of the semantic graph, for example through a relation rdf:type 325 characterizing that an entity corresponds to an instance of a semantic category. This association offers the advantage of providing a representation and semantics common to the entities of the system. Thus, the video surveillance camera C1 315 is for example associated with the category SOSA:Sensor 323 through a relation rdf:type 325 characterizing that the entity “video surveillance camera C1” 315 corresponds to an instance of the semantic category SOSA: Sensor 323.

A hyper-structural graph such as the graph 330 is composed of hyper-nodes, each representing an extensional set having a function that results from the interaction of several entities of the structural graph with each other. Two hyper-nodes can be interlinked by an arc characterizing the relation “is a sub-graph of” 334 (e.g., NGSI-LD: isSubGraphOf). A hyper-node can also be associated with a semantic category of the semantic graph, e.g., by an arc characterizing the relation rdf:type 325. Finally, a node of the structural graph can be linked to a hyper-node by an arc characterizing the relation “is a node of the graph” 332 (e.g., NGSI-LD: isNodeOfGraph).

One or more properties can be associated with a hyper-node, and one or more properties can also be associated with a relation of the hyper-structural graph.

A hyper-node corresponds to the association of several nodes of the structural graph. This level of representation makes it possible for example to characterize as such systems that are physically connected but distributed on a large scale (e.g., the physical infrastructure of a telecommunications network or an energy distribution network); systems whose connections are indirectly physical or purely informational (e.g., a waste collection system, a supply chain, a bike sharing platform); “systems of systems” whose component systems have generally not been designed to work together, and which are functionally independent (e.g., a city, the Internet).

Thus, in the example of FIG. 3, the set of nodes (represented schematically by the box 335) “video surveillance camera C1” (surveillanceCameraC1), “electronic lock LB1” (electronicLockLB1) and “electronic lock LR1” (electronicLockLR1) form a hyper-node “Security System Graph” 331 representing a security system. This hyper-node 331 is associated with another hyper-node 333 representing the building B1 “Building B1 Graph” by a relation (e.g., NGSI-LD: isNodeOfGraph or NGSI-LD: isNodeOfGraph).

The hyper-nodes 333 and 331 constitute instances of the semantic category “NGSI-LD:graph” represented by the node 326, and are therefore linked to the node 326 by arcs representing the relation rdf:type 325.

In the case of a centralized architecture such as the one represented in FIG. 1A, the structural graph and the super-graph are stored on the server 110. In the case of architecture meeting the principles of the edge computing (FIG. 1B), the semantic graph is recorded on the server 110, the structural graph is recorded on the distributed servers 115, and the hyper-structural graph is recorded on the server 110 or on the distributed servers 115. Even more preferably, the structural sub-graphs which represent an object or a part of a system are recorded by a distributed server 115 located in the vicinity of the object or of the part of the system represented. This has the advantage of allowing a processing period to be reduced to a minimum, by allowing an analysis as close as possible to the data sources.

FIG. 4 represents a method for processing a digital model of a system comprising entities, according to one exemplary embodiment of the invention. The method typically makes it possible to optimize the traversal in a digital model, and more particularly to optimize the distribution of the load of a node of the model by avoiding a combinatorial explosion that would make it impossible to obtain a research result.

The method is implemented by an electronic device, for example the server 110 of the system 100. This method can be triggered at regular time intervals, upon receipt of a request from the client 140 by the server 110, or in response to a particular event, for example a response time greater than a predetermined period.

The method comprises a first step 410 aimed at determining that a node of an super-graph of a digital model, such as that of FIG. 3, is capable of creating an overload during traversal of the digital model.

As described below, a piece of information sought (or request) can be formalized by a graph called “pattern graph”, and the graph representing the digital model is then traversed, for example step by step from an initial node. If the number of possibilities to be checked to identify the portion(s) of the digital model which are associated with a given node and which correspond to the information sought is too great, this risks generating an overload or a combinatorial explosion for the given node, and therefore having a negative effect on the processing and response times.

Step 410 is for example implemented by analyzing the super-graph, in particular by determining the indegree or outdegree of at least one of its nodes, and by comparing it with a predetermined value. The indegree is defined as the number of arcs that point to a node. The outdegree is defined as the number of arcs that exit from a node. If the indegree or outdegree is greater than a predetermined value, this means that this node is capable of creating an overload during traversal of the digital model. This value can be predetermined by calculating the average of the indegree or outdegree of the nodes of the super-graph which are the immediate neighbors of the considered node.

As a variant, step 410 can be implemented by analyzing the previously executed requests.

By traversing the graph representing the digital model, it is possible to determine whether the pattern graph corresponds to a sub-graph of the graph representing the digital model. Each node of the super-graph is associated with a counter which is incremented each time the node is accessed. Thus, by comparing the value of the counter associated with a node with a predetermined value, or by comparing the value of the counter associated with a node with the value of the counter associated with other nodes of the super-graph, it is possible to determine the node(s) capable of creating an overload. This value can be predetermined or regularly updated, for example by calculating the average of the values of the counters of the nodes of the super-graph which are immediate neighbors of the considered node.

As a variant, step 410 can be implemented by analyzing the super-graph, in particular by comparing the indegree or outdegree of at least one of its nodes with a predetermined value, and by analyzing the previously executed requests.

When a node of the super-graph capable of creating an overload is identified, an indexing node representing a sub-set inheriting the properties of the set represented by the identified node is generated (step 420). The sub-set is more specific than the set represented by the node capable of creating an overload, and therefore comprises at least one additional characteristic that can correspond either to an additional property, or to an instantiation of at least one of the properties, or to the instantiation of an additional property.

During a step 430, the indexing node and the node capable of creating an overload are linked by an arc representing a relation characterizing the fact that the indexing node represents a more specific set than that of the node capable of creating an overload. If the node capable of creating an overload is a node of the semantic graph, the indexing node is associated with the node capable of creating an overload by the relation “is a subclass of” 324 (e.g., RDFS: SubClassOf), and the indexing node then belongs to the semantic graph. If the node capable of creating an overload corresponds to a node of the hyper-structural graph, the indexing node is associated with the node capable of creating an overload by the relation “is a sub-graph of” 334 (e.g., NGSL-LD:isSubGraphOf), and the indexing node then belongs to the hyper-structural graph.

During a step 440, a sub-set of nodes of the structural graph initially linked to the node capable of creating an overload and which share the additional characteristic is identified. The (direct) association between the nodes of the sub-set and the node capable of creating an overload is removed, and the nodes of the sub-set are associated with the indexing node (step 450), for example by the relation NGSL-LD:type (341).

According to one particular embodiment, when a node of the super-graph capable of creating an overload is identified (410), the properties of the entities represented by the nodes of the structural graph linked to the identified node are analyzed. If it is determined that several of the entities have a property with the same value, for example the same location, an indexing node is generated which has said location (420) as an additional characteristic. Typically, the location is a geographic location. Returning to FIG. 3, the nodes Room B1/R1 311 and Room B1/R2 313 both represent the rooms of a building, and could be associated with the semantic category SAREF: Room 327 which characterizes the rooms of a building. If a significant number of buildings B1, . . . , Bn (e.g., n=100) is represented by the model 300, each node representing a room should be associated with this semantic category 327. After the application of step 410 of the method, the node representing this semantic category could be considered as capable of creating an overload, and a node representing a sub-set 340 (e.g., BuildingB1:Rooms), for example associated with each of the n buildings in a city, could be generated, by application of steps 420, 430, 440 and 450 of the method.

According to another embodiment, when a node of the semantic graph (resp. of the hyper-structural graph) capable of creating an overload is identified (410), the nodes of the structural graph linked to the identified node are analyzed. If it is determined that a predetermined number of analyzed nodes are also associated with another node of the hyper-structural graph (resp. of the semantic graph), the node capable of creating an overload representing a first set, the other node representing a second set, an indexing node is generated (420) which represents a sub-set of the first and second sets.

Returning to FIG. 3, after having determined that the node representing the semantic category SAREF: Room 327 of the semantic graph is capable of creating an overload by application of step 410, a set of nodes that point to this semantic category SAREF: Room 327 is identified. The relations of the nodes in this set are analyzed, and a sub-set of nodes (from said set of nodes) that also point to a node of the hyper-structural graph is identified. When several sub-sets are identified, one of the sub-sets having a number of nodes included in a predetermined interval is selected (for example selection of a sub-set having a number of nodes comprised between 20 and 30% of the number of nodes of the set). More specifically, the analysis makes it possible to determine that the nodes Room B1/R1 311 and Room B1/R2 313 are also associated with the functional set Building B1 Graph 333. By application of step 420, an indexing node BuildingB1:Rooms 340 is generated which represents a sub-set of the semantic category represented by the node capable of creating an overload SAREF:Room 327, and of the functional set Building B1 Graph 333.

FIG. 5 represents a method for searching for information represented by a pattern graph in a digital model of a system such as the digital model processed according to FIG. 4. The method is implemented by an electronic device, for example the server 110 of the system 100. This method or more generally the traversal of a graph-oriented digital model can also be triggered at regular time intervals, upon receipt of a request from the client 140 by the server 110, or in response to a particular event, for example receipt, from physical entities such as digital sensors, connected objects or sensors of the Internet of Things, or electronic devices such as smartphones, of update data. In response to receipt of such data, said electronic device is then configured to search for properties of the nodes or relations between these nodes, and then to update the model. This update corresponds for example to the update of values of these properties, or to the creation/deletion of arcs and/or nodes of the model.

The search method or more generally the traversal of a graph-oriented digital model can also be implemented to predict new information (i.e., new property values, a new node, and/or a new arc representing a new relation) which are not represented by the digital model, to predict a future state of the system it represents, or to make decisions aimed, for example, at limiting the impact of this future state.

Thus, in the case where the digital model is a digital twin of a smart city, said model can be used to track the vehicle traffic, to predict geographic areas in which congestion may occur, or even to make decisions aimed at regulating the traffic.

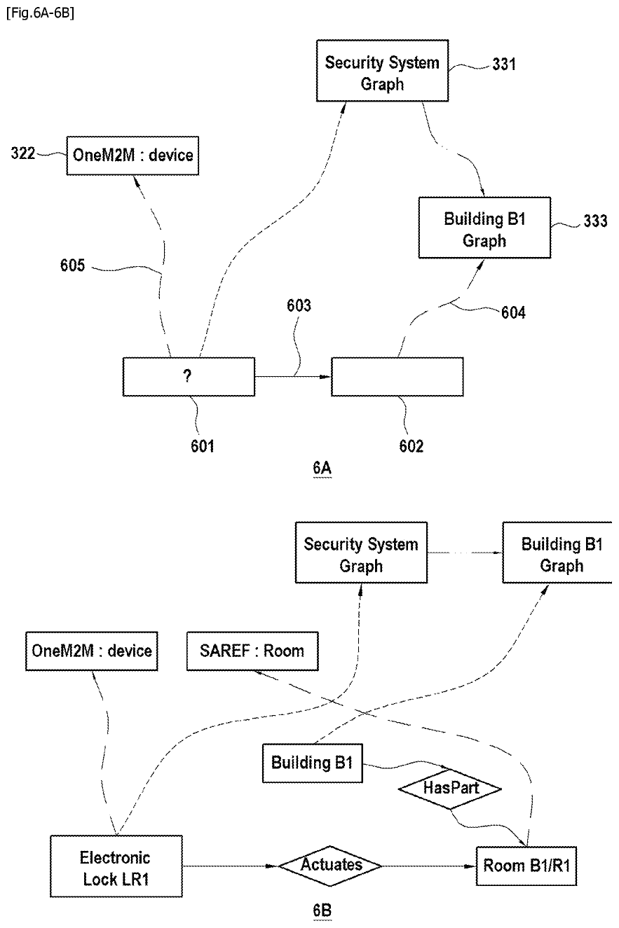

The method comprises a first step 510 aimed at obtaining a pattern graph which represents the information to be sought. In a second step 520, the digital model is traversed, by checking whether it contains the pattern graph as a sub-graph. In theoretical computer science, this step corresponds to the resolution of the sub-graph isomorphism problem, and it is known to use algorithms that solve this NP-complete problem. Finally, during step 530, information that makes it possible to identify the portion of the digital model corresponding to the target graph is obtained.

[FIG. 6A-68] schematically illustrates an example of a graph-oriented request applied on the digital model of FIG. 3 (FIG. 6A), and the result of the application of this request on the digital model represented by FIG. 3 (FIG. 6B),

FIG. 6A illustrates a pattern graph representing information to be sought, here a security device indirectly linked by at least one (structural) entity to the building B1. The pattern graph comprises a node 601 which is the main object of the request, the rest of the pattern graph specifying the satisfiability conditions. The node 601 represents an entity which is a device (relation 605 between the node 601 and the node 322 representing the semantic category OneM2M:Device), which belongs to a security system (relation between the node 601 and the hyper-node 331 representing a security system in the form of a graph). The node 601 is linked by a relation 603 to a node 602 belonging to the structural graph, but the type of relation 603 and of the entity represented by the node 602 are not specified. This node and this relation are sometimes referred to as “wildcard”, since the desired pattern must comprise this node 602 linked by a relation 603 to the node 601, but regardless of the type of the relation or of the entity. In the same way, the relations 604 and 605 are “wildcard” relations since the type of these relations is not explained in the pattern graph/in the request.

An arc of the pattern graph which connects two nodes can be characterized by a maximum number of “hops”, the number of hops depending on a number of intermediate nodes between said nodes in the digital model.

The presence of “wildcard” nodes and/or arcs in a pattern graph considerably broadens the search space, particularly when it is a digital model having a number of significant nodes, since all possible combinations must be considered. Without this invention, such research proves impossible in practice since it generates a combinatorial explosion which makes it impossible to obtain a result.

The invention aims to overcome this drawback, in particular by creating indexing nodes which belong to the structural graph as such. The application of the invention therefore makes it possible to enrich the structural graph with new nodes and new relations. Finally, the invention allows a system making requests on a digital model to use, if necessary, the categories represented by these indexing nodes in order to generate their request.

1. A method for processing a digital model of a system comprising entities, the digital model comprising a structural graph (310) and a super-graph (320, 330), the structural graph representing the entities of the system by interlinked nodes; the super-graph corresponding to an abstraction of the structural graph and comprising nodes representing sets; at least one of the nodes of the structural graph being associated with at least one of the nodes of the super-graph; the method implemented by an electronic device, the method comprising:
determining at least one node of the super-graph capable of creating an overload during traversal of the digital model; and, in response to this determination,
generating an indexing node representing a sub-set of the set represented by the node capable of creating an overload, the sub-set inheriting properties from the set, the sub-set comprising at least one additional characteristic;
associating the indexing node and the node capable of creating an overload;
identifying the nodes of the structural graph directly associated with the node capable of creating an overload and which share the at least one additional characteristic; and
associating the identified nodes with the indexing node.

2. The method of claim 1, wherein the determination of at least one node of the super-graph capable of creating an overload during traversal of the digital model comprises:
determining indegree and/or outdegree of said node, and
comparing the determined indegree and/or outdegree of said node with a predetermined value.

3. The method of claim 1, wherein the determination of at least one node of the super-graph capable of creating an overload during traversal of the digital model comprises analyzing requests previously received by said node.

4. The method of claim 1, further comprising determining that several of the entities represented by nodes of the structural graph associated with the node of the super-graph capable of creating an overload have a same location; in which the generated indexing node has said location as an additional characteristic.

5. The method of claim 1, the super-graph comprising:
a semantic graph comprising nodes, each node representing a set of the super-graph called semantic category, the nodes of the semantic graph being interlinked by arcs representing a subsumption relation or a semantic relation; at least one of the nodes of the structural graph being linked to at least one of the nodes of the semantic graph by an arc characterizing that the at least one of the nodes of the structural graph represents an instance of the semantic category represented by the at least one node of the semantic graph; and,
a hyper-structural graph comprising hyper-nodes, each hyper-node representing a set of the super-graph called extensional set; a hyper-node being associated with a plurality of nodes of the structural graph; and a hyper-node being linked to at least one other hyper-node or to at least one node of the semantic graph, in which the indexing node belongs to the semantic graph and/or to the hyper-structural graph.

6. The method of claim 5, the node capable of creating an overload belonging to the semantic graph, respectively to the hyper-structural graph, the method further comprising determining that several of the nodes of the structural graph associated with the node capable of creating an overload are also associated with another node of the hyper-structural graph, respectively of the semantic graph, the node capable of creating an overload representing a first set, the other node representing a second set, in which the generated indexing node represents a sub-set of the first and second sets.

7. The method of claim 1, wherein the structural graph and at least a portion of the super-graph are stored within a distributed hardware architecture compliant with edge computing.

8. A digital model of a system obtained by the processing method of claim 1.

9. A method for searching for information represented by a pattern graph in the digital model of claim 8, the method implemented by an electronic device, the method comprising:
traversing the digital model by checking whether a portion of the digital model corresponds to the pattern graph; and,
upon a determination that a portion of the digital model corresponds to the pattern graph, obtaining information that makes it possible to identify the portion of the digital model.

10. An electronic device for processing a digital model of a system comprising entities, the digital model comprising a structural graph and a super-graph, the structural graph representing the entities of the system by interlinked nodes; the super-graph corresponding to an abstraction of the structural graph and comprising nodes representing sets; at least one of the nodes of the structural graph being associated with at least one of the nodes of the super-graph; the electronic device comprising:
a module for determining at least one node of the super-graph capable of creating an overload during traversal of the digital model;
a module for generating an indexing node representing a sub-set of the set represented by the node capable of creating an overload, the sub-set inheriting properties from the set, the sub-set comprising at least one additional characteristic;
a module for associating the indexing node and the node capable of creating an overload;
a module for identifying the nodes of the structural graph directly associated with the node capable of creating an overload and which share the at least one additional characteristic; and,
a module for associating the identified nodes with the indexing node.

11. An electronic device for searching for information represented by a pattern graph in the digital model of claim 8, the electronic device comprising:
a module for traversing the digital model by checking whether a portion of the digital model corresponds to the pattern graph; and,
a module for obtaining information that makes it possible to identify the portion of the digital model.

12. A computer comprising a processor and a memory, the memory having stored thereon instructions which, when executed by the processor, cause the computer to implement the method of claim 1.

13. A computer comprising a processor and a memory, the memory having stored thereon instructions which, when executed by the processor, cause the computer to implement the method of claim 9.

14. A non-transitory computer-readable recording medium having stored thereon instructions which, when executed by a processor, cause the processor to implement the method of claim 1.

15. A non-transitory computer-readable recording medium having stored thereon instructions which, when executed by a processor, cause the processor to implement the method of claim 9.
